(19) United States
(12) Patent Application Publication
(10) Pub. No.: US 2023/0331155 A1
(43) Pub. Date: Oct. 19, 2023

(54) MEMORY MODULE, ACTUATOR, REAR VIEW DEVICE AND VEHICLE

(71) Applicant: MOTHERSON INNOVATIONS COMPANY LIMITED, London (GB)

(72) Inventors: Youngmin LEE, Chungcheongbuk-do (KR); Heesung WOO, Chungcheongbuk-do (KR); Il-Sung YU, Chungcheongbuk-do (KR); Chang Kyun HAN, Chungcheongbuk-do (KR); Cheol Ho YIM, Gyeonggi-do (KR)

(21) Appl. No.: 18/188,815

(22) Filed: Mar. 23, 2023

(30) Foreign Application Priority Data
Apr. 13, 2022 (DE) 10 2022 109 075.2

(51) Int. Cl. B60R 1/062; B60R 1/12

(52) U.S. Cl. CPC B60R 1/062; B60R 1/12; B60R 2001/1253

(57) ABSTRACT

According to various embodiments of the present disclosure, a memory module adapted for use with an actuator of a rear view device for a vehicle is provided, wherein the rear view device comprises at least one rear view element which is pivotable around at least one pivot axis, with the memory module being adapted to determine at least one pivot angle of the rear view device and/or the at least one rear view element, and store the at least one determined pivot angle. Further, an actuator with such memory module, a rear view device, a vehicle as well as a method for manufacturing such memory module is provided.

### CROSS-REFERENCE TO RELATED APPLICATION

This application claims priority to German Application No. DE 10 2022 109 075.2, filed on Apr. 13, 2022, the entirety of which is incorporated herein by reference.

### FIELD

The present disclosure relates to a memory module for use with an actuator of a rear view device for a vehicle. Furthermore, the present disclosure refers to an actuator with such a memory module, a rear view device with such an actuator, a vehicle with such a rear view device as well as a method for manufacturing such memory module.

### BACKGROUND

A rear view device, such as an external mirror of a vehicle, may provide the driver with a lateral or rear view of the vehicle. In a specific situation during driving, for example, a situation such as parking, a driver needs to secure a view not only in the lateral or rear direction of the vehicle but also in the downward direction of the vehicle. In addition, it is necessary to provide various viewing angles depending on the driver.

In order to provide a view of the vehicle in various directions, a rear view element (e.g. a mirror element, a display unit or a camera device) attached to the rear view device may be pivoted. The rear view device may comprise an actuator that operates to pivot the rear view element.

The driving mechanism for driving the actuator may comprise a driving motor and a gear structure operated by receiving power from the driving motor.

After the pivoting, in order to return the rear view of the rear view device to the original state, the actuator may comprise a memory module for obtaining, storing, providing and controlling an angle of inclination of the rear view element. In order to be connected to the driving mechanism, the memory module is generally configured with small parts. Thus, manufacturing such small memory modules is complex and at the same time the complexity of memory modules increase their size and lowers the efficiency of the manufacturing process.

### SUMMARY

In view of the aforementioned drawbacks and other inherent in the existing state of the art, it is an object of the present disclosure to further develop the memory modules to overcome at least some of these drawbacks. In particular it is an object to provide a miniaturized memory module, an actuator with such a memory module and a method for manufacturing the same.

This object is accomplished according to the present disclosure by the features set forth in the claims.

Accordingly, a memory module according to embodiments of the present disclosure is adapted for use with an actuator of a rear view device for a vehicle, wherein the rear view device comprises at least one rear view element which is pivotable around at least one pivot axis, with the memory module being adapted to determine at least one pivot angle of the rear view device and/or the at least one rear view element, and store the at least one determined pivot angle. The pivot angle can be determined by any value identifying the pivot angle (e.g. a position of a gear) and thus, can be determined directly or indirectly by e.g. sensing the status of a gear element. In some situation two pivot angles may have to be determined e.g. for the left/right and up/down direction. Furthermore, several pivot angles may be stored in accordance to driving situation or stored configurations e.g. relating to specific drivers.

In an embodiment, the memory module may be further adapted to control the actuator for adjusting the pivot position of the rear view device and/or the at least one rear view element; read-out the at least one stored pivot angle; and/or transmit the at least one stored pivot angle, preferably to a control unit controlling the actuator. In a further embodiment, at least one pivot angle may be transmitted to a control unit controlling the actuator. The controlling function may be implemented via an electric motor. The read-out function may be implemented via an interface such as a USB port and the like and the possibility to read out at least one stored value.

In yet another embodiment the memory module may further comprise a memory gear; a contact member; a circuit board; a support member; a sealing element; and/or a washer.

It is also proposed by embodiments of the present disclosure that the memory gear may comprise a receiving region concavely formed and a first hole and/or is configured to engage with an auxiliary gear of the actuator. The memory gear may comprise a memory gear region for engaging the auxiliary gear on an outer surface thereof.

Furthermore, it is proposed with embodiments of the present disclosure that the contact member may be arranged at the receiving region; the circuit board may comprise a conductor for being electrically in contact with the contact member; the circuit board may provide a second hole preferably being aligned with the first hole; the washer may be arranged above the contact member at the receiving region; and/or the support member may provide an insertion part inserting into the first hole, and supporting the circuit board, wherein preferably the insertion part is inserted into the second hole.

In a further embodiment the sealing element may be arranged below the contact member in the receiving region; the sealing element, the contact member, and the washer may be primarily fixed to the memory gear, and the support member may be secondarily fixed to the fixed memory gear; and/or the sealing element may be an O-ring.

It is also proposed by embodiments of the present disclosure that a forming part formed at one end of the insertion part may be formed by welding and/or the forming part may have a greater diameter than the first hole such that the insertion part is prevented from being separated from the first hole.

Furthermore, the receiving region may comprise a first protrusion part formed adjacent to the first hole and may have a bent shape, wherein the first protrusion part may be adapted to surround and/or cover at least a part of a side part and an upper part of the O-ring, at least a part of a side part and an upper part of the contact member, and at least part of a side part and an upper part of the washer.

Embodiments of the present disclosure may also provide an actuator for a rear view device, comprising at least one memory module outlined above.

In another embodiment according to the present disclosure the actuator may further comprise a lower case; a driving mechanism; an upper cover and a holder.

It is also proposed by embodiments of the present disclosure that the actuator may be adapted to pivot the rear view device and/or the at least one rear view element; the actuator comprises a connection member preferably connected to the holder and the upper cover; and/or the lower case may have an accommodation space formed inside and/or has a bowl shape; the driving mechanism may be arranged in the accommodation space; the holder may be adapted to surround an external surface of the lower case and connected with the driving gear; and/or the memory module may be comprised in the driving mechanism.

In a further embodiment, the driving mechanism may comprise a driving motor, a clutch gear and/or a driving gear.

In yet another embodiment, the clutch gear may comprise a shaft, a pinion gear arranged at one side of the shaft, a main gear arranged adjacent to the pinion gear and configured to receive power from the driving motor, and an auxiliary gear arranged at an end of the other side of the shaft.

In a further embodiment, the driving gear may be configured to operate in engagement with the pinion gear and to rotationally move along an inner surface of the lower case.

It is further proposed, that in embodiments, the sensing function (determining at least one pivot angle) of the memory module may be adapted to determine a moving range of the driving gear.

Embodiments of the present disclosure may also provide a rear view device for a vehicle, comprising at least one memory module outlined above; and/or at least one actuator outlined above. According to a further embodiment the rear view device may comprise the at least one rear view element.

In another embodiment the at least one rear view element may comprise at least one mirror element, display unit and/or camera device; and/or at least one control unit preferably comprising a processor and preferably adapted to control the at least one memory module.

It is furthermore proposed that the rear view device may, in embodiments, be provided in form of an external mirror. The external mirror may, according to a further embodiment, comprise a housing, wherein preferably the at least one memory module and/or the at least one actuator is arranged in the housing.

Embodiments of the present disclosure may provide a vehicle comprising at least one memory module outlined above; at least one actuator outlined above; and/or at least one rear view device outlined above; wherein the vehicle further comprises at least one a control unit preferably comprising a processor and preferably adapted to control the at least one memory module.

The vehicle may comprise a processor electrically connected to the memory module or the processor may be included in the rearview device. The processor may obtain an electrical signal reflecting electrical characteristic (e.g. change of the electrical current between the contact member and the conductor) from the memory module. The processor may be configured to determine an pivot angle of the rearview element based on the electrical signal obtained from the memory module.

Embodiments of the present disclosure may provide a method for manufacturing a memory module outlined above, wherein the method comprises the steps of providing a memory gear comprising a concave receiving region; primarily fixing the sealing element, the contact member, and the washer to the memory gear in the receiving region such that the sealing element, the contact member, and the washer are sequentially arranged in the receiving region; coupling the circuit board and the support member; and secondarily fixing the primarily fixed memory gear and the coupled support member.

According to a further embodiment, it is further proposed that the step of primarily fixing comprises arranging the sealing element, the contact member, and the washer in the receiving region such that at least a part of a side part and an upper part of the sealing element, the contact member, and the washer are surrounded by an first protrusion part formed by welding around the first hole; the step of secondary fixing comprises forming a forming part at an edge region of an insertion part by welding; and/or the step of coupling of the circuit board and the support member comprises inserting an insertion part into a second hole formed in the circuit board.

In embodiments, an auxiliary gear may drive according to the operation of the driving mechanism and the memory gear may be engaging with the auxiliary gear. The area where the contact member and the conductor contact each other may be changed according to rotation of the memory gear. Thus, electrical characteristic or signal (e.g. electrical current between the contact member and the conductor may change according to rotation of the memory gear.

The rear view device may comprise a processor electrically connected to the memory module. Or, the processor may be included in a vehicle. The processor may obtain an electrical signal (e.g. change of the electrical current between the contact member and the conductor) from the memory module. And the processor determines an pivot angle of the rearview element based on the electrical signal obtained from the memory module.

In embodiments, a rear view device may comprise a processor electrically connected to the memory module. The processor may obtain an electrical signal (e.g. change of the electrical current between the contact member and the conductor) from the memory module. And the processor determine an pivot angle of the rearview element based on the electrical signal obtained from the memory module.

According to another embodiment, it is further proposed that the step of secondary fixing may comprise forming a forming part formed at an edge region of an insertion part by welding; the step of primarily fixing may further comprise arranging the sealing element, the contact member, and the washer in the receiving region such that at least a part of a side part and an upper part of the sealing element, the contact member, and the washer are surrounded by an first protrusion part formed by welding around the first hole; and/or the step of coupling of the circuit board and the support member may comprise inserting an insertion part into a second hole formed in the circuit board.

According to an embodiment, the memory module may comprise a memory gear comprising a receiving region concavely formed and a first hole, and configured to engage with an auxiliary gear of the actuator, a contact member arranged at the receiving region, a circuit board comprising a conductor for being electrically in contact with the contact member, a support member having an insertion part inserting into the first hole, and supporting the circuit board, an O-ring arranged below the contact member in the receiving region, and a washer arranged above the contact member, wherein the O-ring, the contact member, and the washer are primarily fixed to the memory gear, and the support member is secondarily fixed to the fixed memory gear.

Embodiments of the present disclosure provide an actuator for a rear view device, such as an external mirror, the actuator comprising at least one memory module.

In a further embodiment, the actuator comprises a lower case having an accommodation space formed inside and having a bowl shape; a driving mechanism arranged in the accommodation space, wherein the driving mechanism comprises, a driving motor; a clutch gear comprising a shaft, a pinion gear arranged at one side of the shaft, a main gear arranged adjacent to the pinion gear and configured to receive power from the driving motor, and an auxiliary gear arranged at an end of the other side of the shaft; a driving gear configured to operate in engagement with the pinion gear and to rotationally move along an inner surface of the lower case; and a memory module adapted to be at least partially engaged with the auxiliary gear and configured to determine a moving range of the driving gear; and a holder adapted to surround an external surface of the lower case and connected with the driving gear; wherein the memory module comprises, a memory gear comprising a receiving region concavely formed and a first hole, and configured to engage with the auxiliary gear, a contact member arranged at the receiving region, a circuit board comprising a conductor for being electrically contact with the contact member, and a support member having an insertion part inserting into the first hole, and supporting the circuit board.

Embodiments of the present disclosure provide rear view device for a vehicle, comprising at least one memory module outlined above and/or at least one actuator outlined above.

Embodiments of the present disclosure provide an external mirror for a vehicle, comprising at least one memory module outlined above and/or at least one actuator outlined above

In a further embodiment, the external mirror comprises a housing wherein the at least one memory module and/or the at least one actuator is arranged in the housing.

According to various embodiments of the present disclosure, an external mirror for a vehicle is provided, the external mirror including: a housing; an actuator arranged in the housing; wherein the actuator includes, a lower case having an accommodation space formed inside and having a bowl shape, a driving mechanism arranged in the accommodation space, wherein the driving mechanism includes, a driving motor; a clutch gear including a shaft, a pinion gear arranged at one side of the shaft, a main gear arranged adjacent to the pinion gear and configured to receive power from the driving motor, and an auxiliary gear arranged at an end of the other side of the shaft, a drive gear adapted to operate in engagement with the pinion gear and to rotationally move along an inner surface of the lower case, and a memory module adapted to be at least partially engaged with the auxiliary gear and adapted to determine a moving range of the drive gear, and a holder adapted to surround an external surface of the lower case and connected with the drive gear, wherein the memory module comprises a memory gear including a receiving region concavely formed and a hole, and configured to engage with the auxiliary gear, a contact member arranged at the receiving region, a circuit board including a conductor for being electrically in contact with the contact member, and a support member having an insertion part inserting into the first hole, and supporting the circuit board.

Embodiments of the present disclosure provide a method for manufacturing a memory module outlined above, the method comprising: preparing a memory gear comprising a concave receiving region; primarily fixing the sealing element, the contact member, and a washer to the memory gear in the receiving region such that the sealing element, the contact member, and the washer are sequentially arranged in the receiving region; coupling a circuit board and a support member; and secondarily fixing the primarily fixed memory gear and the coupled support member. Preferred embodiments of the method are described in the subclaims 19 to 21.

According to an embodiment of the present disclosure, there is provided an external mirror for a vehicle comprising: a housing; an actuator arranged in the housing, having a lower case having an accommodation space formed therein a bowl shape; a driving mechanism arranged in the accommodation space, having a driving motor; a transmission gear comprising a shaft; a pinion gear arranged at one side of the shaft; a main gear arranged adjacent to the pinion gear and configured to receive power from the driving motor; and an auxiliary gear arranged at an end of the other side of the shaft; a driving gear configured to operate in engagement with the pinion gear and to rotationally move along an inner surface of the lower case; and a memory module adapted to be at least partially engaged with the auxiliary gear and determines a moving range of the driving gear; and a holder adapted to surround an external surface of the lower case and connected with the driving gear; wherein the memory module comprises a memory gear having an receiving region concavely formed and a through-hole, and configured to engage with the auxiliary gear; a contact member arranged at the receiving region; a circuit board comprising a conductor for being electrically contact with the contact member; and a support member for supporting the connection part inserting into the through-hole and circuit board.

According to various embodiments, a method for manufacturing a memory module in which two-step fixing is performed is provided, and thus, the manufacturing efficiency of the memory module may be improved.

Other aspects, advantages, and salient features of the present disclosure will become apparent to those skilled in the art from the following detailed description, which taken in conjunction with the annexed drawings, discloses exemplary embodiments of the disclosure, wherein:

### BRIEF DESCRIPTION OF THE DRAWINGS

FIG. 1 is an embodiment of a rear view device in form of an external mirror according to the present disclosure in which an actuator according to the present disclosure is mounted according to an embodiment of the present disclosure.

FIG. 2 illustrates an actuator according to an embodiment of the present disclosure.

FIG. 3 is a perspective view of an actuator according to various embodiments of the present disclosure.

FIG. 4 is a top view of an actuator according to various embodiments of the present disclosure.

FIG. 5 is an exploded perspective view of an actuator according to various embodiments of the present disclosure.

FIG. 6 is a view illustrating a driving mechanism according to various embodiments of the present disclosure on a first side.

FIG. 7 is a view illustrating a driving mechanism according to various embodiments of the present disclosure on a second side.

FIG. 8 is a view illustrating a driving gear and a clutch gear according to various embodiments of the present disclosure.

FIG. 9 is an example of an implementation of a driving mechanism in which a memory module is coupled according to various embodiments of the present disclosure.

FIG. 10 is a front view and a cross-sectional view of a memory module according to various embodiments of the present disclosure.

FIG. 11 is a diagram illustrating a process of manufacturing a memory module according to various embodiments of the present disclosure.

FIG. 12 is a flowchart illustrating a method for manufacturing a memory module according to various embodiments of the present disclosure.

### DETAILED DESCRIPTION

The foregoing objects, features and advantages of the present disclosure will become more apparent from the following detailed description related to accompanying drawings. However, various modifications may be applied to the present disclosure, and the present disclosure may have various embodiments. Hereinafter, specific embodiments, which are illustrated in the drawings, will be described in detail.

In the drawings, the thicknesses of layers and regions may be exaggerated for clarity. When it is indicated that an element or layer is “on” or “above” another element or layer, this comprises a case in which another layer or element is interposed therebetween as well as a case in which the element or layer is directly above the other element or layer. In principle, like reference numerals designate like elements throughout the specification. In the following description, like reference numerals are used to designate elements which have the same function within the same idea illustrated in the drawings of each embodiment.

When detailed description of known functions or configurations related to the present disclosure is deemed to unnecessarily blur the gist of the disclosure, the detailed description thereof will be omitted. Also, numerals (e.g., first, second, etc.) used in the description herein are merely identifiers for distinguishing one element from another element.

In addition, the terms “module” and “unit” used to refer to elements in the following description are given or used in combination only in consideration of ease of writing the specification, and the terms themselves do not have distinct meanings or roles.

Furthermore, the use of a singular term, such as, “a” is not to be interpreted as limiting the number of components or details of particular components. Additionally, various terms and/or phrases describing or indicating a position or directional reference such as, but not limited to, “top”, “bottom”, “front”, “rear”, “forward”, “rearward”, “end”, “outer”, “inner”, “left”, “right”, “vertical”, “horizontal”, etc. may relate to one or more particular components as seen generally from a user's vantage point during use or operation, and such terms and/or phrases are not to be interpreted as limiting, but merely as a representative basis for describing the disclosure to one skilled in the art. In addition, a suffix “region”, “part”, “unit” for a component used in the following description are given or mixed in consideration of only the ease of writing the specification, and do not have meanings or roles distinguished from each other.

The present disclosure relates to a memory module, an actuator for pivoting a rear view device (such as an external mirror for a vehicle) or a rear view element (such as a camera device or a mirror element), an external mirror and a method for manufacturing a memory module.

Hereinafter, an actuator according to an embodiment of the disclosure will be described in general.

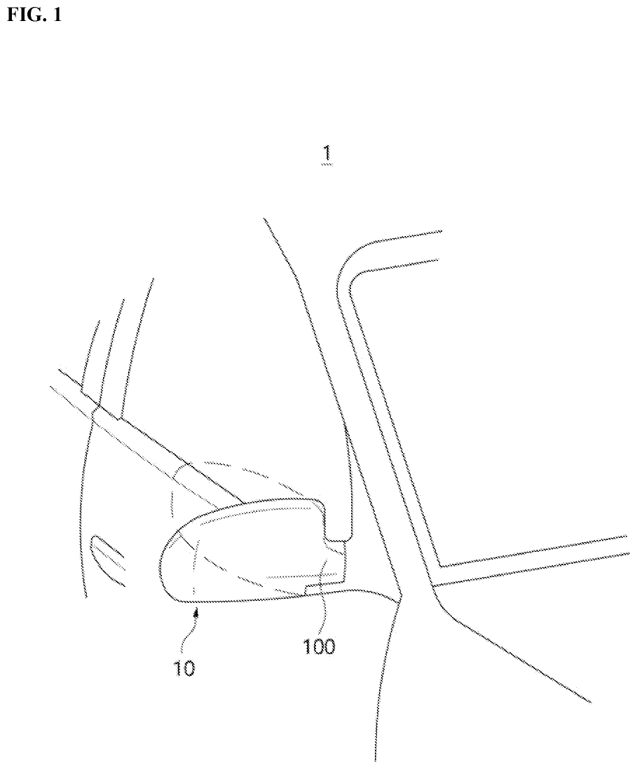

FIG. 1 is an embodiment of a review device according to the present disclosure in which an actuator according to the present disclosure is mounted according to the present disclosure.

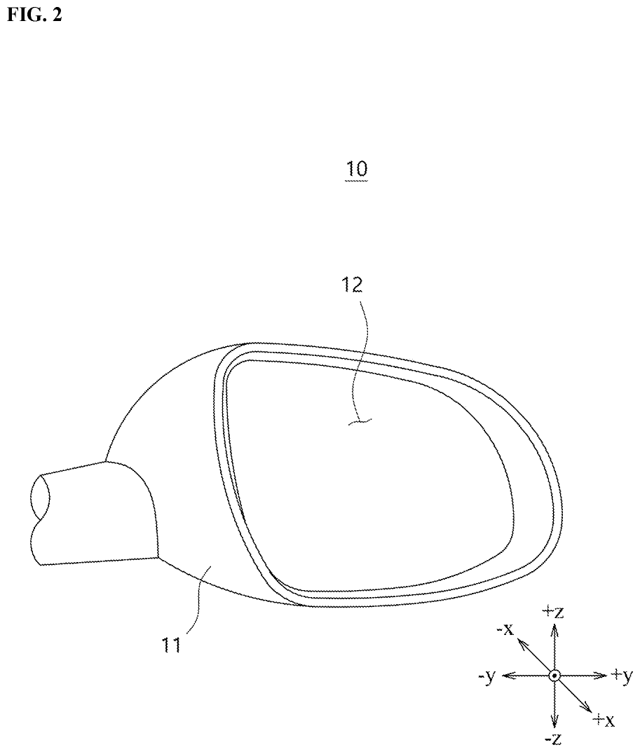

According to the embodiment of FIG. 1 the rear view device is an external mirror. FIG. 2 illustrates an actuator according to an embodiment of the present disclosure.

The following description will be made with reference to FIGS. 1 and 2.

The actuator 100 according to an embodiment of the present disclosure may be mounted on an external mirror 10 arranged outside the vehicle 1. Here, the external mirror 10 may comprise a rear view element 12 providing a rear view to the driver and a housing 11 accommodating the rear view element 12. For example, the rear view element 12 may be a mirror. Alternatively, the rear view element 12 may be implemented as a display that outputs an image obtained by photographing a peripheral region of the vehicle 1. In other embodiments the rear view element is a camera. However, for convenience of description, embodiments in which the rear view element 11 is implemented as a mirror will be mainly described below.

In the present disclosure, an external mirror 10 for a vehicle 1 will be described for convenience of description. However, the external mirror 10 in the present disclosure is not limited to vehicles 1, but may be applied to various transportation units such as a two-wheel moving apparatus (for example, a motor bike).

According to various embodiments of the present disclosure, the actuator 100 may be mounted in the external mirror 10 for a vehicle 1 to perform an operation for pivoting the external mirror for a vehicle 1. For example, the actuator 100 may be accommodated in the housing 11 of the external mirror 10 to provide power to pivot the rear view element 12 mounted on the external mirror 10.

The actuator 100 may operate to pivot the rear view element 12 in all directions with respect to a surface on which the rear view element 12 is arranged. For example, when the rear view element 12 is inclined parallel to the Z-Y axis in the initial state, the actuator 100 may rotate the rear view element 12 with respect to all of the y-axis, the x-axis, and the z-axis.

In the following description of the present disclosure, unless specifically mentioned, the −x-axis direction may refer to the traveling direction of the vehicle 1. For example, the x-axis direction may refer to the rear of the vehicle 1. In addition, the Y-axis direction may refer to a lateral direction of the vehicle 1. For example, the +y-axis direction may refer to a right direction of the vehicle 1, and the −y-axis direction may refer to a left direction of the vehicle 1. In addition, the Z-axis direction may refer to an upper or lower direction of the vehicle 1. For example, the −z-axis direction may refer to a lower direction of the vehicle 1, and the +z-axis direction may refer to an upper direction of the vehicle 1.

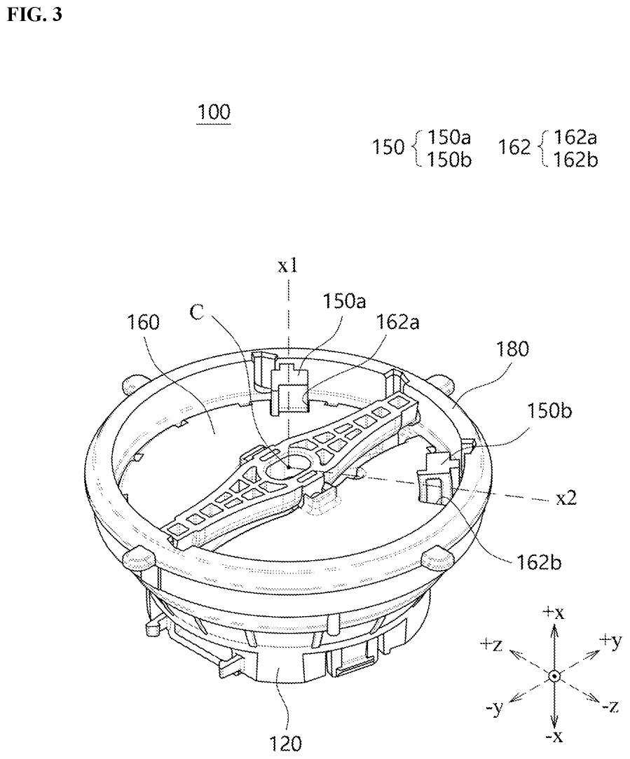

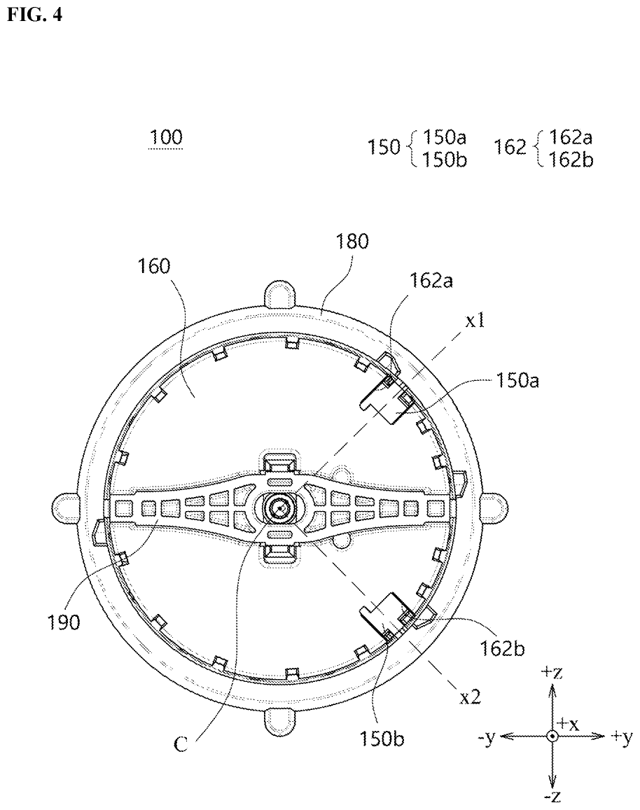

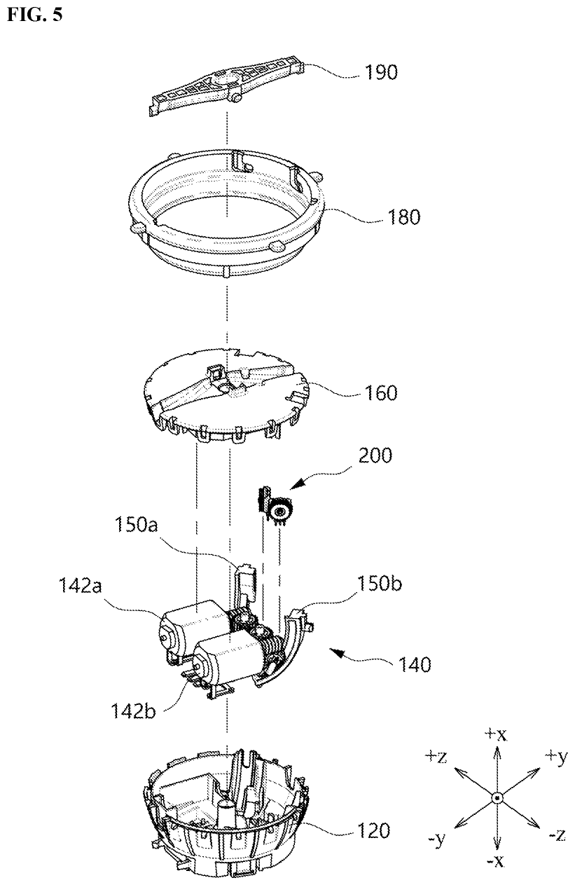

FIG. 3 to FIG. 5 are views of an actuator 100 according to various embodiments of the present disclosure at various angles. FIG. 3 is a perspective view of an actuator 100 according to various embodiments of the present disclosure. FIG. 4 is a top view of an actuator 100 according to various embodiments of the present disclosure. FIG. 5 is an exploded perspective view of an actuator 100 according to various embodiments of the present disclosure.

Referring to FIGS. 3 to 5, the actuator 100 may comprise all or some of the lower case 120, the driving mechanism 140 accommodated in the lower case 120, the upper cover 160 shielding at least a part of the lower case 120, the holder 180 adapted to surround at least partially of the lower case 120, and the connection member 190 connected to the holder 180 and configured to operate by receiving power from the driving mechanism 140. The actuator 100 of FIG. 3 to FIG. 5 may have a configuration that is the same as or similar to the actuator 100 of FIG. 1 and FIG. 2.

According to various embodiments, the lower case 120 may provide a space in which the driving mechanism 140 may be accommodated. For example, the lower case 120 may have a bowl shape in which an accommodation space 121 is formed, and the driving mechanism 140 may be arranged in the accommodation space 121. In an embodiment of the present disclosure, the lower case 120 may be formed such that a width of an upper side (+x-axis direction) is greater than a width of a lower side (−x-axis direction).

According to various embodiments of the present disclosure, the driving mechanism 140 may comprise a driving motor 142 and a driving gear 150. In an embodiment of the present disclosure, the driving motor 142 may comprise first and second driving motors 142a and 142b. However, it will be understood that the illustrated embodiment is exemplary, and fewer or more driving motors may be comprised. In an embodiment according to the present disclosure, the driving motor 142 may be supplied with power from an external power source (e.g., an internal power source of the vehicle 1 of FIG. 1) to operate.

In one embodiment according to the present disclosure, the driving mechanism 140 may comprise a driving gear 150 that operates to pivot the rear view element 12 (e.g., the rear view element 12 of FIG. 2). For example, the driving gear 150 may comprise a first driving gear 150a and a second driving gear 150b. The first driving gear 150a may operate by receiving power of the first driving motor 142a, and the second driving gear 150b may operate by receiving power of the second driving motor 142b. The first driving gear 150a and the second driving gear 150b are symmetrical to each other, and unless specifically mentioned, the description of the first driving gear 150a may be applied to the second driving gear 150b. Hereinafter, for convenience of description, the operation of the first driving gear 150a will be mainly described.

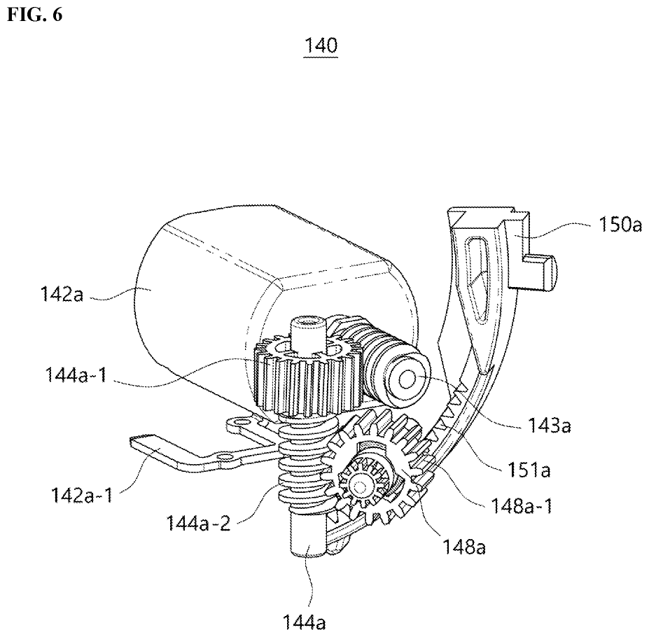

In an embodiment of the present disclosure, the driving mechanism 140 may comprise a memory module 200 for determining and storing a pivoting angle of a rear view element 12 (e.g., the rear view element 12 of FIG. 2). The memory module 200 may comprise a first memory module 200a for determining and storing a pivoting angle related to the first driving motor 142a and the first driving gear 150a, and a second memory module 200b for determining and storing a pivoting angle related to the second driving motor 142b and the second driving gear 150b. The memory module 200 may be connected to a clutch gear 148 (e.g., the first clutch gear 148a of FIGS. 6 to 8) comprised in the driving mechanism 140, as described below, and may determine a pivoting angle corresponding to the rotation of the clutch gear 148.

According to various embodiments of the present disclosure, the upper cover 160 may be arranged on the upper part of the lower case 120 and may shield the accommodation space 121. In an embodiment of the present disclosure, the upper cover 160 may comprise an opening region 162 for providing a moving path of the driving gear 150. For example, the opening region 162 may comprise a first opening region 162a through which the first driving gear 150a passes and a second opening region 162b through which the second driving gear 150b passes.

According to various embodiments of the present disclosure, the holder 180 may be adapted to surround at least partially of the outer surface of the lower case 120. In an embodiment of the present disclosure, the holder 180 may have a ring shape. In an embodiment of the present disclosure, when the holder 180 is viewed from the side surface (e.g., the y-axis direction or the z-axis direction), the width of the lower side (−x-axis direction) may be formed to be smaller than the width of the upper side (+x-axis direction). For example, when viewed from a side surface (e.g., a y-axis direction or a z-axis direction), the holder 180 and the lower case 120 may have shapes corresponding to each other. In an embodiment of the present disclosure, a width (or diameter) of a part (e.g., an upper part (+x-axis direction)) of the holder 180 in the horizontal direction (y-axis or z-axis) may be greater than a width of the widest horizontal direction (y-axis or z-axis) of the lower case 120. In addition, a width of another part (e.g., a lower part (−x-axis direction)) of the holder 180 in the horizontal direction (y-axis or z-axis) may be smaller than a width of at least a part of the upper part (+x-axis direction) of the lower case 120. Accordingly, after the holder 180 and the lower case 120 are assembled, the lower case 120 may be prevented from being separated in the lower vertical direction (−x axis direction) of the holder 180.

In an embodiment of the present disclosure, the holder 180 may be operably connected to the driving gear 150. For example, the holder 180 may be connected to each of the first driving gear 150a and the second driving gear 150b, and may be pivoted with respect to the horizontal plane (e.g., the y-z plane, for example, the surface of the rear view element 12) in correspondence to the operation of the first driving gear 150a and the second driving gear 150b. As the first driving gear 150a and the second driving gear 150b are arranged at right angles to each other, the holder 180 may be pivoted in all directions with respect to the horizontal plane (y-z plane). In an embodiment of the present disclosure, the holder 180 may be connected to the rear view element 12 (e.g., the rear view element of FIG. 2), and the rear view element may be pivoted corresponding to the operation of the holder 180.

In an embodiment of the present disclosure, the connection member 190 may be operably connected between the upper cover 160 and the holder 180. For example, a central part of the connection member 190 may be rotatably connected to a central region of the upper cover 160, and both edges of the connection member 190 may be connected to the holder 180. As a part of the connection member 190 (for example, a central region connected to the upper cover 160) is supported by the upper cover 160, the holder 180 may be stably pivoted.

In an embodiment of the present disclosure, the first driving gear 150a and the second driving gear 150b may be adapted to form a designated angle with respect to a horizontal surface (e.g., a z-y plane) of an upper region of the holder 180. Since the rear view element 12 (e.g., the rear view element 12 of FIG. 2) is arranged above the holder 180, the z-y plane may refer to a surface parallel to the surface of the rear view element 12. For example, the designated angle may be approximately a right angle. As another example, an angle formed by the axis x1 extending from the center point c of the width direction plane (z-y plane) of the actuator 100 to one end of the first driving gear 150a and the axis x2 extending from the center point c to one end of the first driving gear 150a of the second driving gear 150b may be represented as a right angle. As will be described later, the first driving gear 150a may rotate about a direction parallel to the x2 axis, and the second driving gear 150b may rotate about a direction parallel to the x1 axis. For example, the x1 axis may be the same axis as the y axis, and the x2 axis may be the same axis as the z axis. As another example, the x1 axis may be the same axis as the z axis, and the x2 axis may be the same axis as the y axis.

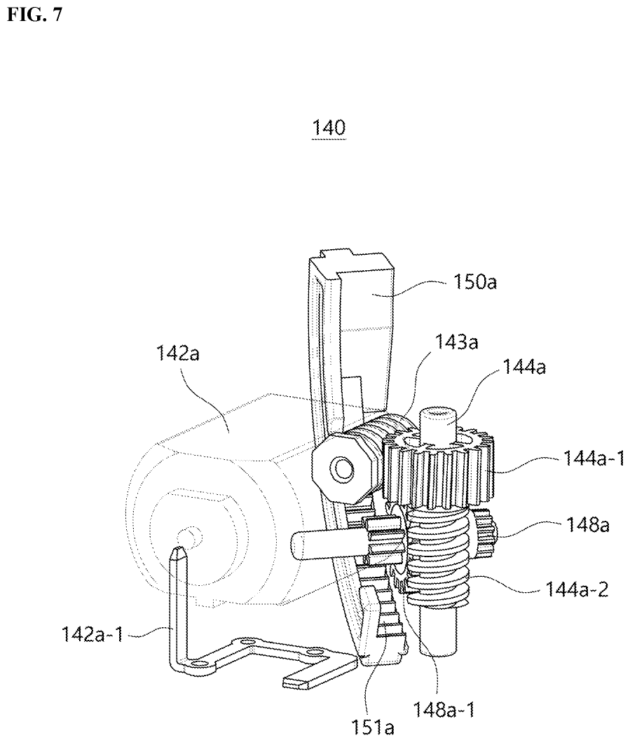

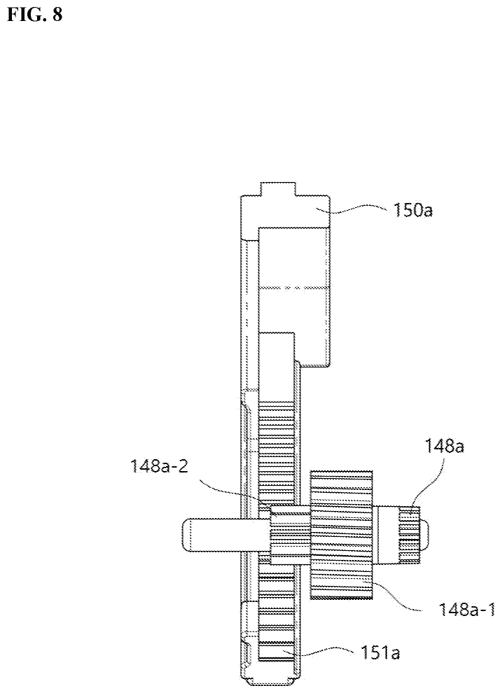

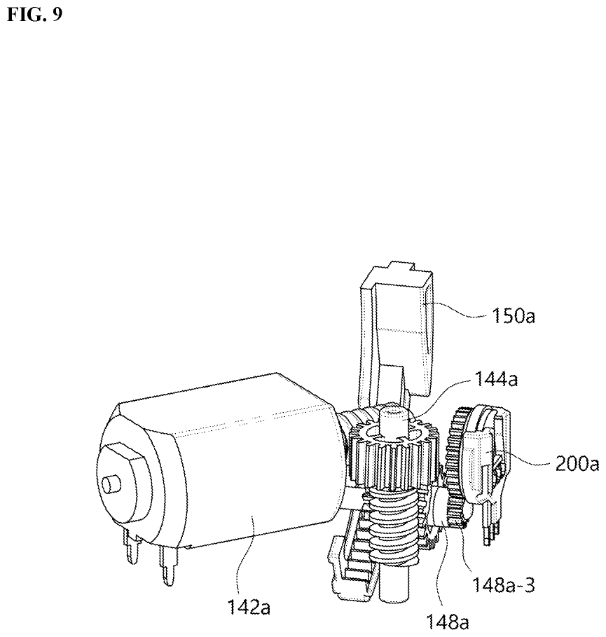

FIG. 6 to FIG. 9 illustrate an embodiment of a driving mechanism according to the present disclosure. FIG. 6 is a view illustrating a driving mechanism 140 according to various embodiments of the present disclosure on a first side; FIG. 7 is a view illustrating a driving mechanism 140 according to various embodiments of the present disclosure on a second side; FIG. 8 is a view illustrating a driving gear 150 and a clutch gear 148 according to various embodiments of the present disclosure. FIG. 9 is an embodiment of a driving mechanism 140 to which a memory module 200 is coupled according to various embodiments of the present disclosure.

Referring to embodiments of FIGS. 6 to 9, the driving mechanism 140 may comprise at least some of a first driving motor 142a, a first transmission gear 144a, a first clutch gear 148a, a first driving gear 150a, and a first memory module 200a. Stated differently, the driving mechanism 140 may be said to comprise a first driving mechanism 140a (a driving mechanism associated with the first driving motor 142a) and a second driving mechanism 140b (e.g., a driving mechanism associated with the second driving motor 142b). The description of the driving mechanism 140 (e.g., the driving mechanism 140 of FIG. 5) in the above-described embodiments may be applied to the driving mechanism 140 of FIGS. 6 to 8.

According to various embodiments of the present disclosure, the first driving motor 142a may comprise a first terminal 142a-1 and a first output gear 143a. The first terminal 142a-1 may be electrically connected to the outside of the first driving motor 142a (e.g., internal power of the vehicle 1) to receive power for operating the first driving motor 142a. In an embodiment of the present disclosure, the first terminal 142a-1 may be connected to another terminal or a circuit board arranged in the lower case 120 (e.g., the lower case 120 of FIG. 5), or may be connected to another terminal outside the lower case 120. The first output gear 143a may transmit the power of the first driving motor 142a to other components.

According to various embodiments of the present disclosure, the first transmission gear 144a may be connected to the first output gear 143a. In addition, the first transmission gear 144a may be connected to the first clutch gear 148a. In other words, the first transmission gear 144a may connect the first output gear 143a and the first clutch gear 148a. In an embodiment of the present disclosure, the first transmission gear 144a may comprise a first transmission part 144a-1 for connecting with the first output gear 143a and a second transmission part 144a-2 for connecting with the first clutch gear 148a. In an embodiment of the present disclosure, the first transmission part 144a-1 and the second transmission part 144a-2 may transmit power in different directions, or may transmit power in the same direction. For example, the first transmission part 144a-1 may be provided as a spur gear or a helical gear, and the second transmission part 144a-2 may be provided as a worm gear.

According to various embodiments, the first clutch gear 148a may comprise a first part 148a-1 for receiving power from the first transmission gear 144a and a second part 148a-2 for engaging with at least a part of the first driving gear 150a. In one embodiment of the present disclosure, the first part 148a-1 may be provided as a spur gear or a helical gear to engage the second part 148a-2. In addition, the second part 148a-2 may be provided as a pinion gear to engage the first driving gear 150a. In an embodiment of the present disclosure, the first part 148a-1 and the second part 148a-2 may share the same axis but have different diameters. For example, the second part 148a-2 provided as a pinion gear may have a smaller diameter than the first part 148a-1. When divided into sizes, the first part 148a-1 may be referred to as a main gear, and the second part 148a-2 may be referred to as a pinion gear.

According to various embodiments of the present disclosure, the first driving gear 150a may comprise a first driving region 151a to be engaged with the second part 148a-2. In an embodiment of the present disclosure, the first driving region 151a may be provided as a rack gear. In addition, the first driving gear 150a may have a smoothly curved shape. For example, the first driving gear 150a may be arc-shaped. Since the first driving gear 150a has an arc shape, the first driving gear 150a may smoothly perform a revolve motion based on the central axis of the arc (e.g., the x2 axis of FIG. 4) in correspondence with the operation of the second part 148a-2. In addition, the first driving gear 150a may move along an inner surface of the lower case 120, as described below. To this end, the shape of the outer surface of the first driving gear 150a and the shape of the inner surface of the lower case 120 may correspond to each other. For example, the curvature of the outer surface of the first driving gear 150a may be substantially the same as the curvature of the inner surface of the lower case 120.

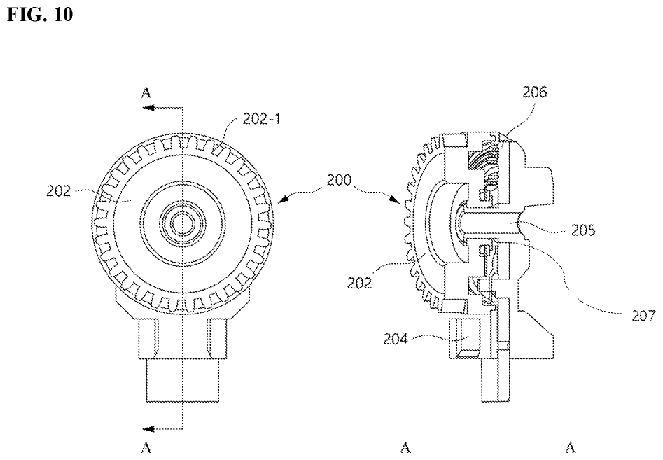

In an embodiment of the present disclosure, the first clutch gear 148a may comprise a first auxiliary gear 148a-3 for connection with the first memory module 200a. The first auxiliary gear 148a-3 may be formed at an end of the first clutch gear 148a. The first auxiliary gear 148a-3 may have a gear shape and may be engaged with a memory gear (e.g., the memory gear region 202-1 of FIG. 10) of the first memory module 200a.

In the above description and the following description of the present disclosure, the first driving gear 150a and various components for driving the first driving gear 150a (e.g., the first driving motor 142a, the first transmission gear 144a, and the first clutch gear 148a) will be mainly described. As described above, the description of this can be equally (or symmetrically) applied to the second driving gear 150b and the components for driving the second driving gear 150b. That is, it will be understood that the driving mechanism 140 may comprise all or some of a second driving gear 150b (e.g., the second driving gear 150b of FIG. 4) and components for driving the same (e.g., the second driving motor 142b, the second transmission gear 144b, and the second clutch gear 148b), similar to the first driving gear 150a.

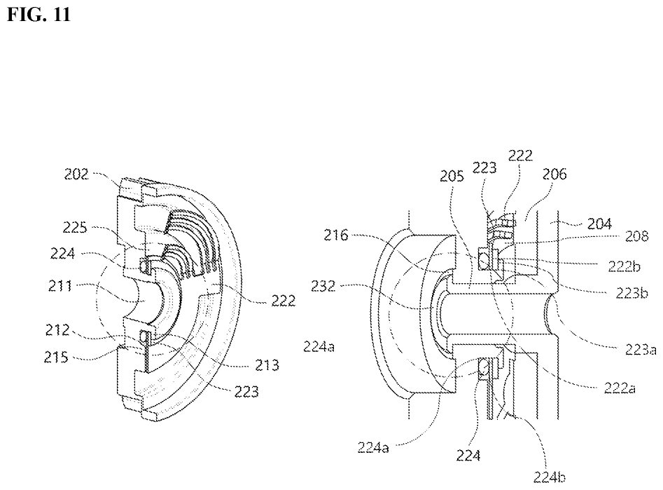

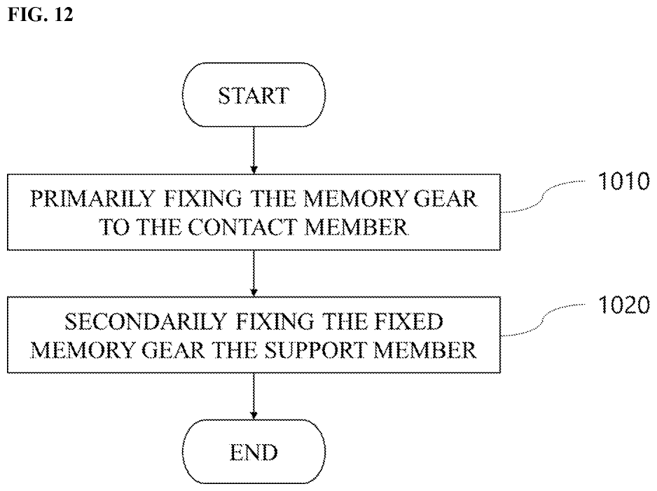

FIG. 10 and FIG. 11 illustrate a memory module 200 according to various embodiments of the present disclosure. FIG. 10 is a front view and a cross-sectional view of a memory module 200 according to various embodiments of the present disclosure. FIG. 12 is a diagram illustrating a process of manufacturing a memory module 200 according to various embodiments of the present disclosure.

Referring to FIGS. 10 and 11, the memory module 200 may comprise all or some of a memory gear 202, a contact member 222, a washer 223, an O-ring 224, a support member 204, and a circuit board 206. The memory module 200 of FIGS. 9 and 10 may be the same as the memory module 200 of FIG. 5.

According to various embodiments of the present disclosure, the support member 204 may form an overall external appearance of the memory module 200 and may provide a space in which components constituting the memory module 200 may be arranged. For example, the circuit board 206 may be arranged on the support member 204, and the memory gear 202 may be adapted to cover at least a part of the circuit board 206.

In an embodiment of the present disclosure, the support member 204 may comprise an insertion part 205 and a forming part 232. The insertion part 205 may protrude from at least a part of the support member 204 and may be adapted to pass through at least a part of the circuit board 206 and the memory gear 202. The forming part 232 may be formed in an edge region of the insertion part 205. The forming part 232 may be formed by welding. The forming part 232 may be formed to have a larger diameter than the first hole 211, thereby preventing the insertion part 205 from being separated from the first hole 211. For example, in a state in which the insertion part 205 is inserted into the first hole 211, the end of the insertion part 205 made of metal or polymer material is processed at high temperature and the forming part 232 may be formed. The forming part 232 may rotate under the support area 216. In an embodiment of the present disclosure, the width of the forming part 232 may be greater than the width of the insertion part 205. Accordingly, after the support member 204 is coupled to the memory gear 202, the memory gear 202 may be prevented from being separated.

According to various embodiments, the memory gear 202 may comprise a first hole 211, a support 216, a receiving region 212 that may be a groove, an first protrusion part 213, and a second protrusion part 215. The first hole 211 may receive the insertion part 205 of the support member 204 as described above. The receiving region 212 may be formed on a surface opposite to the surface on which the memory gear region 202-1 is formed. The receiving region 212 may be formed adjacent to the first hole 211. The O-ring 224, the contact member 222, and the washer 223 may be sequentially arranged in the receiving region 212. A second protrusion part 215 may be formed on one side (e.g., a side surface opposite to the first hole 211) of the receiving region 212 to surround all or some side surfaces of the O-ring 224, the contact member 222, and/or the washer 223. An first protrusion part 213 may be formed on the other side (e.g., in a direction adjacent to the first hole 211) of the receiving region 212 to surround side surfaces and a part of an upper part of the O-ring 224, the contact member 222, and the washer 223. In an embodiment of the present disclosure, the receiving region 212 may be formed around the first hole 211. For example, the receiving region 212 may be formed along an outer circumferential surface of the first hole 211. Accordingly, the second protrusion part 215 and the first protrusion part 213 may also be formed along an outer circumferential of the first hole 211. The first protrusion part 213 may extend from the first hole 211 to surround the O-ring 224, the contact member 222, and/or the washer 223. The first protrusion part 213 may surround or cover at least part of both a side part 224a and an upper part 224b of the O-ring 224, at least part of a side part 222a and an upper part 222b of the contact member 222, and at least part of a side part 223a and an upper part 223b of the washer. The first protrusion part 213 may be formed to fix the O-ring 224, the contact member 222, and/or the washer 223. The contact member 222 may rotate under the first protrusion part 213. Similar to the forming part 232, the first protrusion part 213 and the second protrusion part 215 may also be formed by processing at high temperature. In one embodiment of the present disclosure, the memory gear 202 comprises a memory gear region 202-1, and the memory gear region 202-1 can be engaged with the auxiliary gear 148a-3 described above in FIG. 9.

According to various embodiments, the O-ring 224 may be arranged at the bottom of the receiving region 212, and the contact member 222 may be arranged at an upper part of the O-ring 224, such that the O-ring 224 may elastically support the contact member 222. A washer 223 may be arranged on the contact member 222, and the washer 223 may fix a position of the contact member 222. A conductor 208 for contacting the contact member 222 may be arranged on the circuit board 206. The conductor 208 may be arranged on a surface of the circuit board 206. An electrical characteristic transmitted to the circuit board 206 is changed according to a contact area where the contact member 222 and the conductor 208 are in contact with each other or a contact position between the conductor 208 and the contact member 222, and thus the memory module 200 may determine a rotation angle of the driving gear 150, which refers to a respective pivot angle of the rear view element 12.

The vehicle 1 (e.g the vehicle 1 in FIG. 1) may comprise a processor electrically connected to the memory module 200 or the processor may be included in the rearview device 10. The processor may obtain an electrical signal reflecting electrical characteristic (e.g. change of the electrical current between the contact member 222 and the conductor 208) from the memory module 200. The processor is configured to determine an pivot angle of the rearview element based on the electrical signal obtained from the memory module 200. For example, the memory gear 202 may be adapted to be engaged with the auxiliary gear 148a-3 (e.g., the auxiliary gear 148a-3 of FIG. 9). The memory gear 202 may comprise a memory gear region 202-1 for engaging the auxiliary gear 148a-3 on an outer surface thereof. When the memory gear 202 rotates corresponding to the operation of the auxiliary gear 148a-3, the contact member 222 coupled with the memory gear 202 also rotates, and the electrical signal applied to the circuit board 206 may be changed.

In manufacturing the memory module 200 comprising the above-described components, a two-step fixing process may be performed for the efficiency of the process. Hereinafter, a process of manufacturing the memory module 200 according to various embodiments of the present disclosure will be described.

FIG. 12 is a flowchart illustrating a method of manufacturing a memory module according to various embodiments of the present disclosure. In describing the flowchart of FIG. 12, the description of FIGS. 10 and 11 or reference numerals may be mentioned together.

Referring to FIG. 12, the method of manufacturing the memory module 200 may comprise primarily fixing the memory gear 202 to the O-ring 224, the contact member 222, and the washer 223 (1010), and secondarily fixing the fixed memory gear 202 to the circuit board 206 and the support member 204 (1020).

In the primary fixing step 1010, an O-ring 224 may be arranged in the receiving region 212 of the memory gear 202. After the O-ring 224 is arranged, the contact member 222 and the washer 223 may be sequentially arranged on the O-ring 224. Thereafter, the first protrusion part 213 may be formed, and the O-ring 224, the contact member 222 and the washer 223 may be vertically fixed by the first protrusion part 213.

In an embodiment of the present disclosure, at least a part of the O-ring 224, the contact member 222, and the washer 223 may be arranged below the first protrusion part 213. In one embodiment of the present disclosure, the contact member 222 may be contacted to the first surface 225 of the memory gear 202 in some regions and spaced apart from the memory gear 202 in other regions. A part of the contact member 222 spaced apart from the memory gear 202 may contact a contact member (not shown) formed on the circuit board 206.

In a secondary fixing step 1020, memory gear 202 may be coupled with support member 204. The forming part 232 of the support member 204 may be formed by welding. Specifically, the support member 204 is fixed to the memory gear 202 by the forming part 232. The forming part 232 may be formed at one end of the insertion part 205 and may have a diameter greater than that of the first hole 211. Accordingly, the forming part 232 may be adapted to cover the support 216, which is a peripheral region of one side of the first hole 211. In an embodiment of the present disclosure, the support member 204 and the memory gear 202 may be coupled to each other in a state in which the support member 204 and the circuit board 206 are coupled to each other. As another example, the support member 204, the circuit board 206, and the memory gear 202 may be sequentially stacked and coupled to each other. The circuit board 206 may comprise a separate opening, and the separate opening may be adapted to overlap the first hole 211. The insertion part 205 may be adapted to pass through both the opening formed in the circuit board 206 and the first hole 211.

According to various embodiments of the present disclosure, there is provided an actuator 100 comprising: a lower case 120 (e.g., the lower case 120 of FIG. 5) having an accommodation space 121 formed therein a bowl shape; a driving mechanism 140 (e.g., the driving mechanism 140 of FIG. 5) arranged in the accommodation space 121, having a driving motor 142; a transmission gear 144 comprising a shaft; a pinion gear arranged at one side of the shaft; a main gear arranged adjacent to the pinion gear and configured to receive power from the driving motor 142; and an auxiliary gear 148a-3 arranged at an end of the other side of the shaft; a driving gear 150 configured to operate in engagement with the pinion gear and to rotationally move along an inner surface of the lower case 120; and a memory module 200 (e.g., the memory module 200 of FIG. 5) adapted to be at least partially engaged with the auxiliary gear 148a-3 and determines a moving range of the driving gear 150; and a holder 180 (e.g., the holder 180 of FIG. 5) adapted to surround an external surface of the lower case 120 and connected with the driving gear 150; wherein the memory module 200 comprises a memory gear 202 (e.g., the memory gear 202 of FIG. 10) having an receiving region 212 concavely formed and a first hole 211, and configured to engage with the auxiliary gear 148a-3; a contact member 222 (e.g., the contact member 222 of FIG. 11) arranged at the receiving region 212; a circuit board 206 (e.g., the circuit board 206 of FIG. 11) comprising a conductor 208 for being electrically contact with the contact member 222; and a support member 204 (e.g., the support member 204 of FIG. 11) having a insertion part 205 inserting into the first hole 211 and supporting the circuit board 206.

According to an embodiment of the present disclosure, the memory module 200 may further comprise an O-ring 224 (e.g., the O-ring 224 of FIG. 11) arranged below the contact member 222 in the receiving region 212; and a washer 223 (e.g., the washer 223 of FIG. 11) arranged above the contact member.

According to an embodiment of the present disclosure, the actuator 100 may be provided in which the O-ring 224, the contact member 222, and the washer 223 are primarily fixed to the memory gear 202, and the support member 204 is secondarily fixed to the fixed memory gear 202.

According to an embodiment of the present disclosure, an actuator 100 may be provided in which a forming part 232 formed at one side end of the insertion part 205 and a support area 216 formed to be flat around the first hole 211 are welded to each other.

According to an embodiment of the present disclosure, an actuator 100 may be provided in which the receiving region 212 may comprise an first protrusion part 213 formed adjacent to the first hole 211 and having a bent shape, and the first protrusion part 213 may be adapted to surround at least a side part 224a of the O-ring 224, a side part 222a of the contact member 222, and a side part 223a of the washer, and the first protrusion part 213 may be adapted to surround at least of a upper part 223b of the washer 223.

According to various embodiments of the present disclosure, a method for manufacturing a memory module 200 is provided, the method comprising: preparing a memory gear 202 (e.g., the memory gear 202 of FIG. 11) comprising a concave receiving region 212; primarily fixing the O-ring 224, the contact member 222, and the washer 223 to the memory gear 202 in the receiving region 212 so that the O-ring 224, the contact member 222, and the washer 223 are sequentially arrange; coupling a circuit board 206 (e.g., the circuit board 206 of FIG. 11) and a support member 204 (e.g., the support member 204 of FIG. 11); and secondarily fixing the primarily fixed memory gear 202 and the coupled support member 204.

According to an embodiment of the present disclosure, the secondary fixing may comprise welding and coupling between a forming part 232 formed at an edge region of the connection part and a support 216 formed to be flat around a first hole 211 formed in the memory gear 202.

According to an embodiment of the present disclosure, the primarily fixing may further comprise arranging the O-ring 224, the contact member 222, and the washer 223 in the receiving region 212 such that at least a part of a side part and an upper part of the O-ring 224, the contact member 222, and the washer 223 are surrounded by an first protrusion part 213 formed around the first hole 211.

Furthermore, a second hole (207) is formed in the circuit board (206). The second hole (207) may be aligned with the first hole (211), and the insertion part (205) may be inserted into the first hole (211) and the second hole (207). According to an embodiment of the present disclosure, the coupling of the circuit board 206 and the support member 204 may comprise inserting the connection part into a second hole formed in the circuit board 206.

According to an embodiment of the present disclosure, there is provided an external mirror 10 for a vehicle 1 comprising: a housing 11 (e.g., the housing 11 of FIG. 2); an actuator 100 (e.g., the actuator 100 of FIG. 3) arranged in the housing 11, having a lower case 120 (e.g., the lower case 120 of FIG. 5) having an accommodation space 121 formed therein a bowl shape; a driving mechanism 140 (e.g., the driving mechanism 140 of FIG. 5) arranged in the accommodation space 121, having a driving motor 142; a transmission gear 144 comprising a shaft; a pinion gear arranged at one side of the shaft; a main gear arranged adjacent to the pinion gear and configured to receive power from the driving motor 142; and an auxiliary gear 148a-3 arranged at an end of the other side of the shaft; a driving gear 150 configured to operate in engagement with the pinion gear and to rotationally move along an inner surface of the lower case 120; and a memory module 200 (e.g., the memory module 200 of FIG. 5) adapted to be at least partially engaged with the auxiliary gear 148a-3 and determines a moving range of the driving gear 150; and a holder 180 (e.g., the holder 180 of FIG. 5) adapted to surround an external surface of the lower case 120 and connected with the driving gear 150; wherein the memory module 200 comprises a memory gear 202 (e.g., the memory gear 202 of FIG. 10) having an receiving region 212 concavely formed and a through-hole, and configured to engage with the auxiliary gear 148a-3; a contact member 222 (e.g., the contact member 222 of FIG. 11) arranged at the receiving region 212; a circuit board 206 (e.g., the circuit board 206 of FIG. 11) comprising a conductor 208 for being electrically contact with the contact member 222; and a support member 204 (e.g., the support member 204 of FIG. 11) for supporting the connection part inserting into the through-hole and circuit board 206.

As described above, although the embodiments are described by the limited embodiments and the drawings, various modifications and changes may be made by those skilled in the art from the above description. For example, appropriate results may be achieved even if the described techniques are performed in a different order than the described method, and/or components of the described system, structure, apparatus, circuit, etc. are combined or combined in a different form than the described method, or replaced or substituted by other components or equivalents.

Therefore, other implementations, other embodiments, and those equivalent to the claims also fall within the claims to be described below.

### REFERENCE SIGNS

1 vehicle
10 external mirror
11 housing
12 rear view element
100 actuator
120 lower case
121 accommodation space
140 driving mechanism
142 driving motor
142a, 142b first, second driving motor
142a-1 first terminal
143 output gear
143a, 143b first, second output gear
144 transmission gear
144a-1, 144a-2 first, second transmission part
144a, 144b first, second transmission gear
148 clutch gear
148a-1, 148a-2 first, second part
148a, 148b first, second clutch gear
148a-3 auxiliary gear
150 driving gear
150a, 150b first, second driving gear
151a, 151b first, second driving region
160 upper cover
162 opening region
162a, 162b first, second opening region
180 holder
190 connection member
200 memory module
200a, 200b first, second memory module
202-1 memory gear region
202 memory gear
204 support member
205 insertion part
206 circuit board
207 second hole
208 conductor
211 first hole
212 receiving region
213 first protrusion part
215 second protrusion part
216 support area
222 contact member
222a side part of the contact member
222b upper part of the contact member
223 washer
223a side part of the washer
223b upper part of the washer
224 O-ring
224a side part of the O-ring
224b upper part of the O-ring
225 first surface
232 forming part
1010 primary fixing step
1020 secondary fixing step

1-19. (canceled)

20. A rear view device for a vehicle, comprising:
a rear view element that is pivotable around a pivot axis; and
a memory module configured to determine a pivot angle of at least one of the rear view device or the rear view element, and store the determined pivot angle.

21. The rear view device of claim 20, further comprising:
an actuator configured to adjust a pivot position of at least one of the rear view element or the rear view device,
wherein the memory module is further configured to control the actuator for adjusting the pivot position.

22. The rear view device of claim 20, further comprising:
an actuator configured to adjust a pivot position of at least one of the rear view element or the rear view device; and
a control unit configured to control the actuator for adjusting the pivot position,
wherein the memory module is further configured to read-out the stored pivot angle and transmit the stored pivot angle to the control unit for controlling the actuator.

23. The rear view device of claim 20, further comprising:
a memory gear that includes a receiving region concavely formed and that defines a first hole, wherein the memory gear is configured to engage with an auxiliary gear of the actuator.

24. The rear view device of claim 23, further comprising:
a contact member that is disposed at the receiving region; and
a circuit board that includes a conductor for being electrically in contact with the contact member, wherein the circuit board defines a second hole that is aligned with the first hole.

25. The rear view device of claim 24, further comprising:
a washer that is disposed above the contact member at the receiving region.

26. The rear view device of claim 24, further comprising:
a support member that provides an insertion part inserting into the first hole and supporting the circuit board.

27. The rear view device of claim 26, wherein the insertion part is further inserted into the second hole.

28. The rear view device of claim 24, further comprising:
a sealing element disposed below the contact member in the receiving region.

29. The rear view device of claim 28, wherein the sealing element is an O-ring.

30. The rear view device of claim 26, a forming part at one end of the insertion part is formed by welding.

31. The rear view device of claim 30, wherein the forming part has a greater diameter than the first hole such that the insertion part is prevented from being separated from the first hole.

32. The rear view device of claim 29, wherein the receiving region comprises a first protrusion part formed adjacent to the first hole and having a bent shape.

33. The rear view device of claim 32, wherein the first protrusion part is configured to surround and/or cover at least a part of a first side part and a first upper part of the O-ring, at least a part of a second side part and a second upper part of the contact member, and at least part of a third side part and a third upper part of the washer.

34. The rear view device of claim 20, further comprising:
an actuator configured to adjust a pivot position of at least one of the rear view element or the rear view device, the actuator comprising
a lower case,
a driving mechanism,
an upper cover, and
a holder.

35. The rear view device of claim 34, wherein
the actuator comprises a connection member connected to the holder and the upper cover,
the lower case has an accommodation space formed inside and/or has a bowl shape, and
the driving mechanism is arranged in the accommodation space.

36. The rear view device of claim 35, wherein the holder is configured to surround an external surface of the lower case and connected with the driving gear.

37. The rear view device of claim 36, wherein the memory module is included in the driving mechanism.

38. The rear view device of claim 37, the driving mechanism comprises
a driving motor,
a clutch gear comprising a shaft, a pinion gear disposed at one side of the shaft, a main gear disposed adjacent to the pinion gear and configured to receive power from the driving motor, and an auxiliary gear disposed at an end of the other side of the shaft, and
a driving gear configured to operate in engagement with the pinion gear and to rotationally move along an inner surface of the lower case.

39. The rear view device of claim 38, wherein a sensing function of the memory module is configured to determine a moving range of the driving gear.

40. The rear view device of claim 20, wherein the rear view element includes a mirror element, display unit, and/or camera device.

41. The rear view device of claim 22, wherein the control unit includes a processor that is configured to control the memory module.

42. The rear view device of claim 20, wherein the rear view device is provided in form of an external mirror.

43. The rear view device of claim 42, wherein the memory module and an actuator are arranged in the housing.

44. A rear view device for a vehicle, comprising:
a rear view element that is pivotable around a pivot axis;
a memory module configured to determine a pivot angle of at least one of the rear view device or the rear view element, and store the determined pivot angle;
a memory gear that includes a receiving region concavely formed and that defines a first hole, wherein the memory gear is configured to engage with an auxiliary gear of the actuator;
a contact member that is disposed at the receiving region;
a circuit board that includes a conductor for being electrically in contact with the contact member, wherein the circuit board defines a second hole that is aligned with the first hole;
a washer that is disposed above the contact member at the receiving region; and
a support member that provides an insertion part inserting into the first hole and supporting the circuit board,
wherein the sealing element, the contact member, and the washer are primarily fixed to the memory gear, and the support member is secondarily fixed to the memory gear.

45. A method for manufacturing a memory module according to claim 26, comprising:
providing the memory gear with a concave receiving region;
primarily fixing the sealing element, the contact member, and the washer to the memory gear in the receiving region such that the sealing element, the contact member, and the washer are sequentially arranged in the receiving region;
coupling the circuit board and the support member; and
secondarily fixing the primarily fixed memory gear and the coupled support member.

46. The method of claim 45, wherein the step of primarily fixing comprises arranging the sealing element, the contact member, and the washer in the receiving region such that at least a part of a side part and an upper part of the sealing element, the contact member, and the washer are surrounded by a first protrusion part formed by welding around the first hole.

47. The method of claim 45, wherein the step of secondary fixing comprises forming a forming part at an edge region of an insertion part by welding.

48. The method of claim 45, wherein the step of coupling of the circuit board and the support member comprises inserting an insertion part into a second hole formed in the circuit board.

49. A memory module for use with an actuator of a rear view device for a vehicle, wherein the rear view device comprises a rear view element which is pivotable around a pivot axis, the memory module comprising:
a memory gear that includes a receiving region that is concavely formed and that defines a first hole,
wherein the memory gear is configured to engage with an auxiliary gear of the actuator, and
wherein the memory module is configured to determine a pivot angle of at least one of the rear view device or the rear view element, and store the determined pivot angle.

50. The memory module of claim 49, wherein the memory module is further configured to control the actuator for adjusting the pivot position of at least one of the rear view device or the rear view element, read-out the stored pivot angle, and transmit the stored pivot angle to a control unit for controlling the actuator.

51. The memory module of claim 50, further comprising:
a contact member that is disposed at the receiving region; and
a circuit board that includes a conductor for being electrically in contact with the contact member, wherein the circuit board defines a second hole that is aligned with the first hole.

52. The memory module of claim 51, further comprising:
a washer that is disposed above the contact member at the receiving region.

53. The memory module of claim 52, further comprising:
a support member that provides an insertion part inserting into the first hole and supporting the circuit board.

54. The memory module of claim 53, wherein the insertion part is further inserted into the second hole.

55. The memory module of claim 53, further comprising:
a sealing element disposed below the contact member in the receiving region.

56. The memory module of claim 55, wherein the sealing element, the contact member, and the washer are primarily fixed to the memory gear, and the support member is secondarily fixed to the memory gear.

57. The memory module of claim 55, wherein the sealing element is an O-ring.

58. The memory module of claim 53, a forming part at one end of the insertion part is formed by welding.

59. The memory module of claim 58, wherein the forming part has a greater diameter than the first hole such that the insertion part is prevented from being separated from the first hole.

60. The memory module of claim 57, wherein the receiving region comprises a first protrusion part formed adjacent to the first hole and having a bent shape.

61. The memory module of claim 60, wherein the first protrusion part is configured to surround and/or cover at least a part of a first side part and a first upper part of the O-ring, at least a part of a second side part and a second upper part of the contact member, and at least part of a third side part and a third upper part of the washer.

62. The memory module of claim 50, wherein the control unit includes a processor that is configured to control the memory module.

63. The memory module of claim 49, wherein the memory module and an actuator are arranged in a housing of the rear view device.

64. A vehicle that includes the memory module of claim 49.

65. An actuator for a rear view device of a vehicle, wherein the rear view device comprises a rear view element which is pivotable around a pivot axis, the actuator comprising:
a lower case;
an upper cover;
a driving mechanism disposed in the lower case; and
a memory module, included in the driving mechanism, the memory module comprising a memory gear that includes a receiving region that is concavely formed and that defines a first hole, wherein the memory gear is configured to engage with an auxiliary gear of the actuator, and wherein the memory module is configured to determine a pivot angle of at least one of the rear view device or the rear view element, and store the determined pivot angle;

66. The actuator of claim 65, further comprising a holder that is configured to surround an external surface of the lower case and is connected with the driving gear.

67. The actuator of claim 65, further comprising a connection member connected to the holder and the upper cover.

68. The actuator of claim 65, wherein the lower case has an accommodation space formed inside and/or has a bowl shape.

69. The actuator of claim 68, wherein the driving mechanism is arranged in the accommodation space.

70. The actuator of claim 65, wherein the driving mechanism comprises
a driving motor,
a clutch gear comprising a shaft, a pinion gear disposed at one side of the shaft, a main gear disposed adjacent to the pinion gear and configured to receive power from the driving motor, and an auxiliary gear disposed at an end of the other side of the shaft, and
a driving gear configured to operate in engagement with the pinion gear and to rotationally move along an inner surface of the lower case.

71. The actuator of claim 70, wherein a sensing function of the memory module is configured to determine a moving range of the driving gear.
